(19) United States
(12) Patent Application Publication
(10) Pub. No.: US 2017/0142299 A1
(43) Pub. Date: May 18, 2017

(54) Bodyband

(71) Applicant: Justin Brown, Union City, NJ (US)

(72) Inventor: Justin Brown, Union City, NJ (US)

(21) Appl. No.: 14/487,886

(22) Filed: Sep. 16, 2014

Related U.S. Application Data
(60) Provisional application No. 61/882,908, filed on Sep. 26, 2013.

(51) Int. Cl. H04N 5/225; G06F 1/16

(52) U.S. Cl. CPC H04N 5/2252; G06F 1/163

(57) ABSTRACT

A body mounted system to store a mobile device and or camera. The device relates to a camera or mobile device harness in which the user can wear the device on the body; by way of an elastic strap and a separate case. The belt portion of the Bodyband can be formed of any flexible material, allowing for a comfortable, snug and adjustable fit around the torso area. The docking mount and the belt portion are affixed. The docking mount is padded on the rear and slightly rigid. Located on the front side of the docking mount portion of the Bodyband is a surface to which the case is attached by a fastening mechanism. The case has two sides. The rear of the case has Velcro or any other fastening mechanism on the surface. The front of the case has Velcro or any fastening mechanisms as well.

### SUMMARY OF THE INVENTION

This device relates to the storing or wearing a mobile device or camera. Many active individuals today are looking for ways to capture video images of activities they perform from a first person perspective. Many active people look for ways to wear their mobile devices during physical activity or just taking a walk. The challenge of capturing video while performing activities can be dangerous or even impossible. This device allows the user to capture video. This device also doubles as a mobile device holder that can be worn and easily and accessed on the fly. When an individual needs to access their mobile device, it is as simple as pulling off the device. When an individual is finished, he/she can reconnect the device by simply placing the case back on the Velcro docking station.

There are currently a few limited options for wearable video camera devices or wearable mobile device accessories that are functional. U.S. Pat. No. 6,028,627 discloses a camera system that captures the perspective of the user. A mount structure is located proximate to the mouth guard of a safety helmet. U.S. 2007/280675 ANS 2006008269 disclose wearable wrist or arm camera harness. However, the harnesses of these arrangements use a mechanical clasping system which can only be fixed to suitably modified cameras and this is not suitable for universal attachment of cameras or mobile devices. Another device called the bullet camera, examples of which are shown in JP 7.131,697 and U.S. Pat. No. 5,583,571, which can be mounted to a user's head or headwear using a bead strap mount, or to headwear such as a helmet using suction mounts. However, there are problems with this method. Bullet cameras require handheld controllers to be attached to the camera to operate. Using this method may be less convenient and more cumbersome. Another disadvantage of that design is the time it takes to setup and the wires that get in the way coming from the camera to the main unit mounted on the body of the user. Another disadvantage is the prohibitive cost of this device.

The proposed device addresses all of the previous issues of the other inventions and improves the design. The present design seeks to provide a chest strap mount for a camera or mobile device having a quick release system, which has advantages over known systems. Also this system allows the user to access a mobile device and remount the device with case.

Having a first person perspective while capturing video of an unmodified camera or mobile device, along with a quick release mechanism is what makes this device unique. The first aspect of this device provides body mounted support for a mobile device or camera formed of a strap suitable for attachment on a user's torso comprising a case suitable for a mobile device or camera. The present device provides a user to simply and effectively mount a mobile device or camera to the torso. By mounting a mobile device or camera in this manner, the user can record video and store the mobile device with ease while the user is in motion or at rest.

### BRIEF DESCRIPTION OF THE DRAWINGS

The device is described further by hereinafter, by way of example only, with reference to the accompanying drawings, in which is displayed the preferred embodiment of the device.

FIG. 1 is a front view of the body belt being worn with the rear portion of the case shown

FIG. 2A is back view of the camera or mobile device case

FIG. 3 is the elongated front view of the body belt

FIG. 3A is an elongated rear view of the body belt

FIG. 4 is the front view of the camera or mobile device case

FIG. 5 is a front view of the body belt being worn with the front portion of the case shown

FIG. 6 is a rear view of the body belt being worn

### DETAILED DESCRIPTION

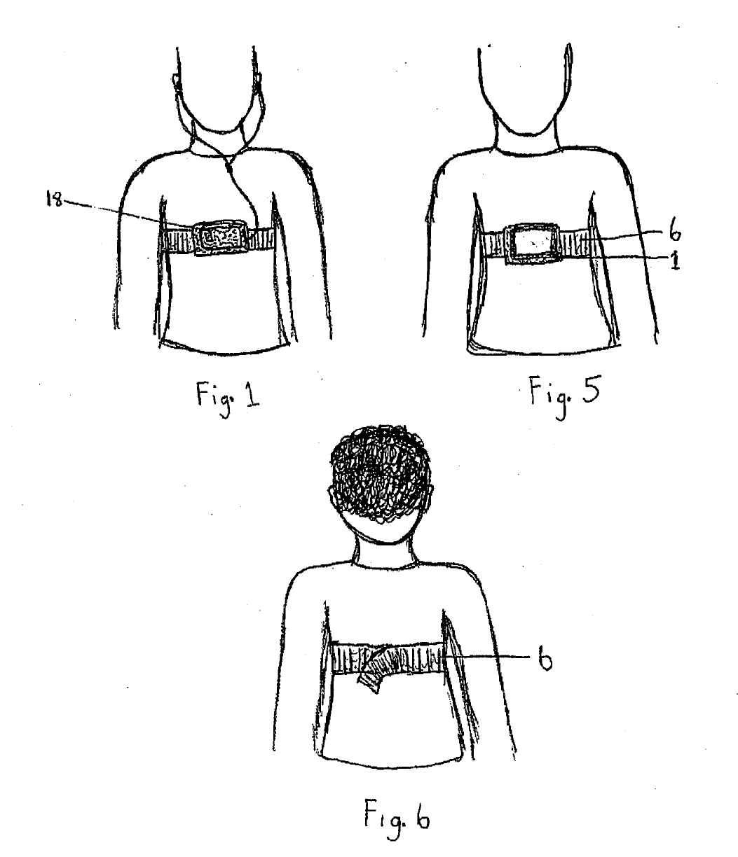

In overview and with reference to FIG. 1 the present device generally comprises a case 18 for mounting camera or mobile device to the torso area of the user. The case 18 attaches to the docking Velcro mount or any other clasping mechanism 1 on the body belt 6 and the case 18 is where the mobile device or camera is inserted. The body belt 6 may be constructed of an elastic material 4, except for the non-elastic zone 10, which is made of any water resistant material. The body belt 6 is formed by a continuous loop of material which has Velcro fasteners or any other type of fastener mechanism 3 that allow for opening and closing of the body belt 6 at variable sizes. The body belt 6 is comfortably held on the user by the elastic force of the material against the torso. The case 18 is may be constructed of a flexible plastic or any rubber material that allows for a snug, secure fit that molds to the shape of the camera or mobile device.

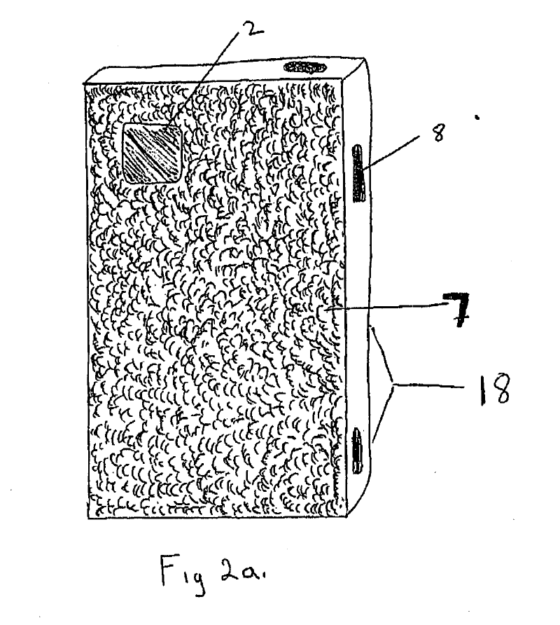

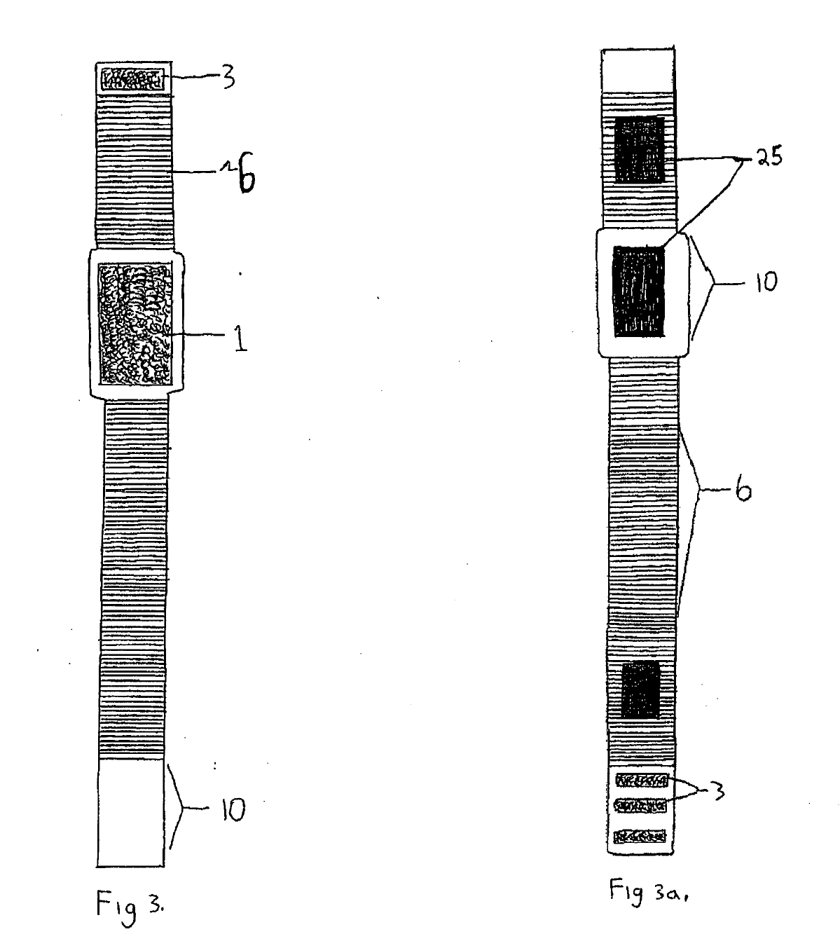

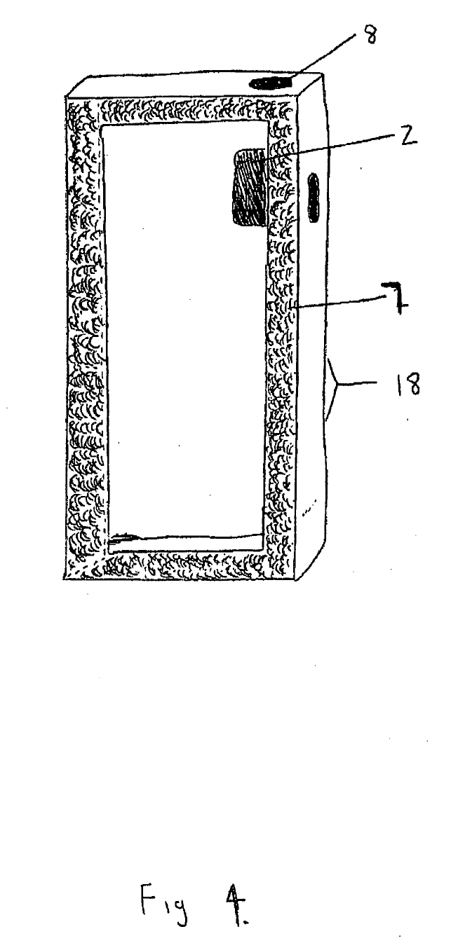

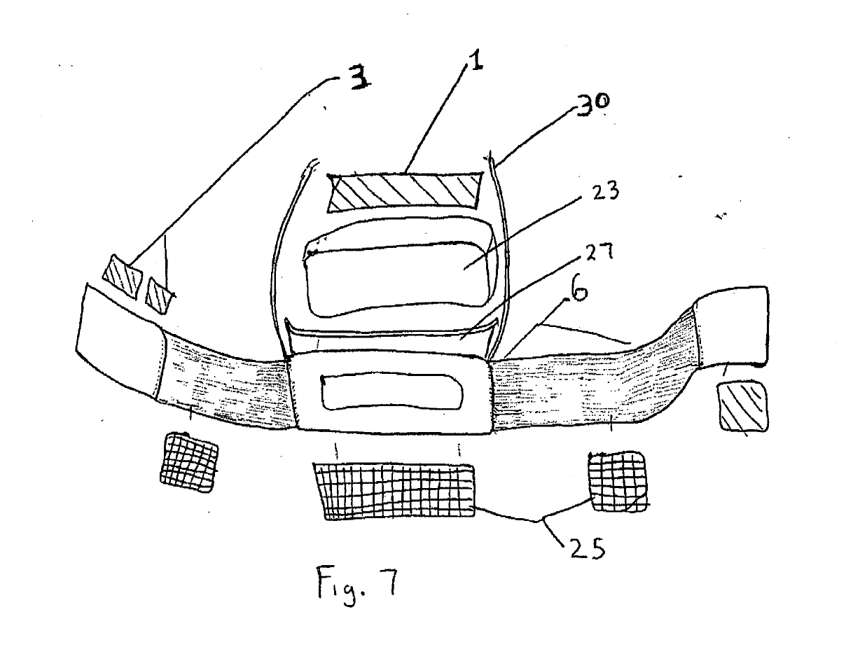

Alternatively, as shown in FIG. 1 the body belt 6 as discussed suitable for mounting a mobile device for convenient use while in motion or a camera to capture video images. At each end on the body belt 6 can comprise a Velcro fasteners 3 which allow for a secure and convenient system to secure the body belt 6 on the user and adjust length on the body belt 6. Alternatively, as show in FIG. 2A, the support or case 18 for the camera or mobile device can include cut away area 8 that allow the user to access functions on the camera or mobile device. The case 18 of the device and the body belt 6 are separate items. The Velcro fasteners 3 on the body belt 6, and the docking Velcro mount 1 allow for quick and secure separation and fastening to the case Velcro 7, as shown in FIG. 2a and FIG. 4. The lens opening 2 allows for the capture of video or still images. As shown in FIG. 4. The case Velcro is located on both sides of the case, which allows for either side of the mobile device case to be accessible to the user. FIG. 1 and FIG. 5 demonstrate the position of the device while worn On the body.

What is claimed is:

1. A body mounted case for a mobile device or camera which encircles the torso area of the user. Comprising a body belt and a case. In the case, which is worn on the user, is stored a camera or mobile device. The device can be used to capture video or still images, or to conveniently store a mobile device with easy access.

2. A body belt of wherein the strap is that forms a band which can be opened or closed with fasteners.

3. The case of claim 1 is formed of a flexible and strong material that is closely molded to the shape of the mobile device or camera in which the case firmly wraps around and contours the shape of the camera or mobile device.

4. The case of claim 1, has a surface cover on one side of the camera or mobile device, except for lens aperture.

5. The case of claim 3, wherein the top panel includes one or more cut away areas to allow access to the camera or mobile device.

6. The body belt of claim 2, wherein the body belt is adjustable for different sized users

7. The body bad of claim 2, wherein the body belt uses fasteners on each end of the body belt.

8. The case of claim 3, located on the front and back side of the case is Velcro or a fastener mechanism

9. The body belt of claim 2, wherein on the front side of the body belt is a docking station composed of Velcro or a fastener mechanism where the said case is connected in a firm and secure manner.

10. The case of claim 3, is made of a durable water resistant material.

11. The case of claim 3, the front side of the surface area may comprise Velcro.

12. The case of claim 3, the back side of the surface area may comprise Velcro.

13. The case of claim 9, the docking station section has padding on the back side.
